(19) United States
(12) Patent Application Publication
(10) Pub. No.: US 2010/0043140 A1
(43) Pub. Date: Feb. 25, 2010

(54) Component Frame Assembly for Patient Lift Devices

(75) Inventor: Mark Chepurny, Bradford (CA)

Correspondence Address: THE WEBB LAW FIRM, P.C., 700 KOPPERS BUILDING, 436 SEVENTH AVENUE, PITTSBURGH, PA, 15219, US

(73) Assignee: PRISM MEDICAL LTD., Vaughan (CA)

(21) Appl. No.: 12/507,877

(22) Filed: Jul. 23, 2009

(30) Foreign Application Priority Data
Jul. 24, 2008 (CA) 2638276

(51) Int. Cl. A61G 7/10

(52) U.S. Cl. 5/85.1

(57) ABSTRACT

A component frame assembly for a patient lift device, the component frame assembly comprising: first and second opposed frame plates, and at least one plate connector connecting the plates, the plates and plate connector being sized, shaped and positioned such that the plates are separated by an interior component space and so as to define an opening to the interior component space between an edge of the first plate and an edge of the second plate, each plate having an inner side facing the interior component space and an opposite outer side; a force transmitter coupled to the plates and positioned in the interior component space; a force applicator mounted to the outer side of one of the first and second frame plates.

### FIELD OF THE INVENTION

This invention relates generally to the field of mobility devices, and more particularly, to personal lift devices of the type that may be used to move a physically disabled patient horizontally and vertically.

### BACKGROUND OF THE INVENTION

Personal lift or patient lift devices have been known and used in the past for the purpose of assisting with the movement of patients. An attendant may help physically disabled patients who are elderly, or who may have suffered a traumatic injury, stroke, or one form of illness or another, and who are unable to move about adequately on their own. However, often, such patients may be too heavy to lift, or the attendant may not have enough strength to help the patient move. This can be especially true for disabled patients who have reduced mobility, but otherwise normal bodily functions. Getting up, going to the bathroom, or having a bath, are examples of activities that can be very difficult for such patients.

One common type of personal lift device comprises an overhead track fixed to the ceiling. A rail carriage or trolley, having wheels, is mounted to the overhead track. A motor is operatively connected to and positioned immediately beneath the trolley to power it, and the motor also has a lift associated with it, which lift includes a strap or chain hanging down and connecting to a harness which holds the patient. The track is typically organized to extend over the patient's bed, as well as into a bathroom area used by the patient. The patient can be raised, suspended, and moved to a desired position along the track, where the patient can be lowered into the bathtub, onto a toilet, or into bed. Typically, the movement of the trolley along the track, and the lift up and down, is controlled by an electronic controller, having buttons that are pressed by the attendant.

Another kind of personal lift device is a portable lift. In such a device, a frame, comprising one or more legs carrying an overhead track, can be transported and set up where needed. A portable lift is transported with the frame, and connected to the track for use in lifting, moving and lowering the patient. In such a lift, the lifting and lowering functions are typically motorized. Lateral movement is typically accomplished by applying force manually, though it may also be motorized in some cases. A strap connects the lift to the track. The strap is retracted to lift the patient or extended to lower him.

Whatever the specific type of patient lift used, it is typical for such lifts to have the motor, gear and other components mounted within a component box. The components typically include gears of different sizes cooperating to afford mechanical advantage to the motor to facilitate lifting of the patient. Also typically contained in the component box is a spool for winding or unwinding a strap to lift or lower the patient.

The box typically consists of a cube or similar six-sided shape, with five metal walls welded together, and one of the sides being partially open to permit the strap to move in and out.

### SUMMARY OF THE INVENTION

What is desired is a component frame assembly for a patient lift that provides a framework for the secure mounting of, inter alia, lift components, but that provides easier access to the components mounted in or on the framework (e.g. for maintenance purposes) than is available in the prior art. Preferably, components requiring frequent maintenance and/or replacement can be easily accessed, or replaced, without dismantling the framework.

Therefore, according to the present invention, there is provided a component frame assembly for a patient lift device, the component frame assembly comprising:

first and second opposed frame plates, and at least one plate connector connecting the plates, the plates and plate connector being sized, shaped and positioned such that the plates are separated by an interior component space and so as to define an opening to the interior component space between an edge of the first plate and an edge of the second plate, each plate having an inner side facing the interior component space and an opposite outer side;

a gear assembly coupled to the plates and positioned in the interior component space;

a motor mounted to the outer side of one of the first and second frame plates; and

a controller mounted to the outer side of one of the first and second frame plates.

Optionally, the assembly further comprises a power source, the power source being coupled to the plates and positioned on an outer side of one of the plates. Optionally, the opening extends over at least fifty percent of the perimeter of the plates. Optionally, the assembly includes a patient connector retraction and extension device positioned in the interior component space adjacent said opening. Optionally, the patient connector retraction and extension device comprises a spool for retracting and extending a patient connector. Optionally, the assembly further comprises at least one limit switch to limit operation of the motor, the limit switch being positioned on an outer side of one of the plates. Optionally, the assembly further comprises at least one current-controlling fuse, the fuse being positioned on an outer side of one of the plates. Optionally, the power source comprises a pair of batteries. Optionally, the controller comprises a circuit board that includes control circuitry. Optionally, the assembly further comprises a power source coupled to the plates and positioned on an outer side of one of the plates, and the circuit board is positioned between one of the plates and the power source. Optionally, the motor is positioned on an outer side of the first plate. Optionally, the assembly further comprises at least one limit switch to limit operation of the motor, the limit switch being positioned on the outer side of the first plate. Optionally, the controller is positioned on an outer side of the second plate. Optionally, the power source is coupled to the plates and positioned toward an outer side of the second plate.

### BRIEF DESCRIPTION OF THE DRAWINGS

The invention will now be illustrated by way of example only, in the attached drawings, which show the preferred embodiment of the invention, and in which:

FIG. 1 is an elevation view of a personal lift device and track;

FIG. 2 is a perspective view of the lift with the housing removed, showing the preferred component frame assembly;

FIG. 3 is a first exploded view of the component frame assembly;

FIG. 4 is a second exploded view of the component frame assembly.

### DETAILED DESCRIPTION OF THE PREFERRED EMBODIMENTS

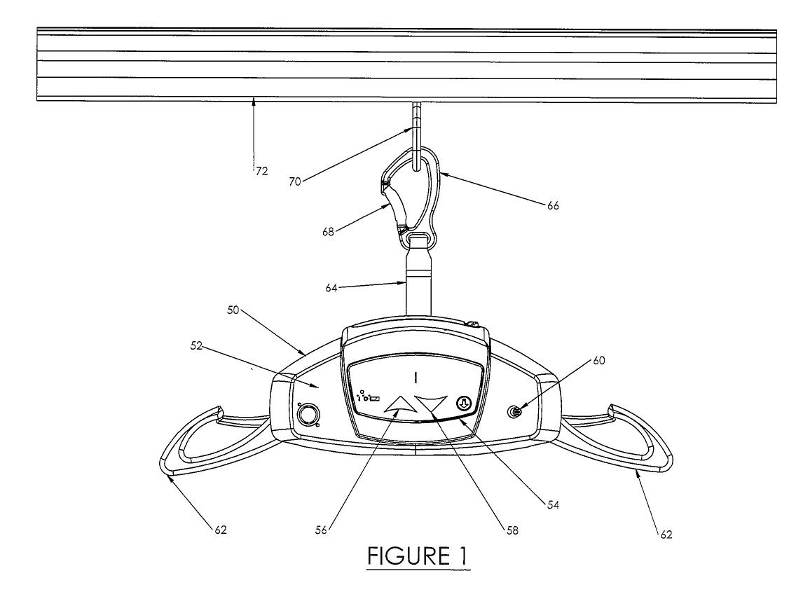

Referring now to FIG. 1, an example portable patient lift 50 is shown. The lift 50 includes housing 52 carrying control panel 54. Control panel 54 includes up button 56 and down button 58. When these buttons are pressed, the motor of lift 50 is actuated to either raise or lower the patient (not shown). The lift further includes connector 60 for receiving a remote control (not shown) which allows a user to raise and lower the patient while being positioned away from the lift 50. The lift 50 further includes harness supports 62. The harness supports 62 hold a patient harness (not shown), which in turn carries the patient (not shown).

A patient connector, preferably in the form of a lift strap 64, extends outward from the top of lift 50. The strap 64 is operatively connected to the motor within the lift 50, and the motor causes the strap 64 either to extend, thus lowering the patient, or to be retracted, thus raising the patient. The strap is attached to carabiner 66 having an openable closure 68 for unhooking the carabiner 66 from hook 70. The hook 70 is attached to a trolley (not shown) mounted on wheels within track 72. Thus, when the lift is pushed in one direction or the other, it can be moved along track 72.

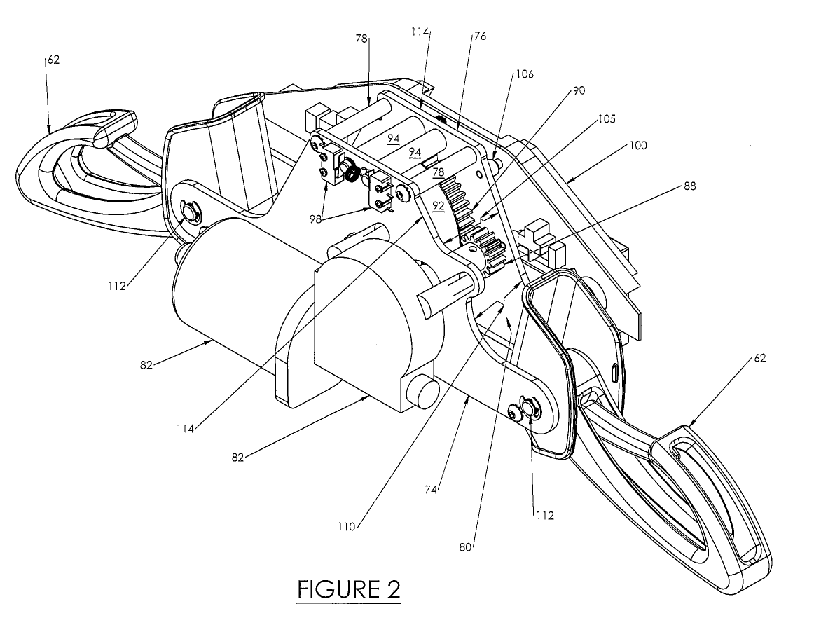

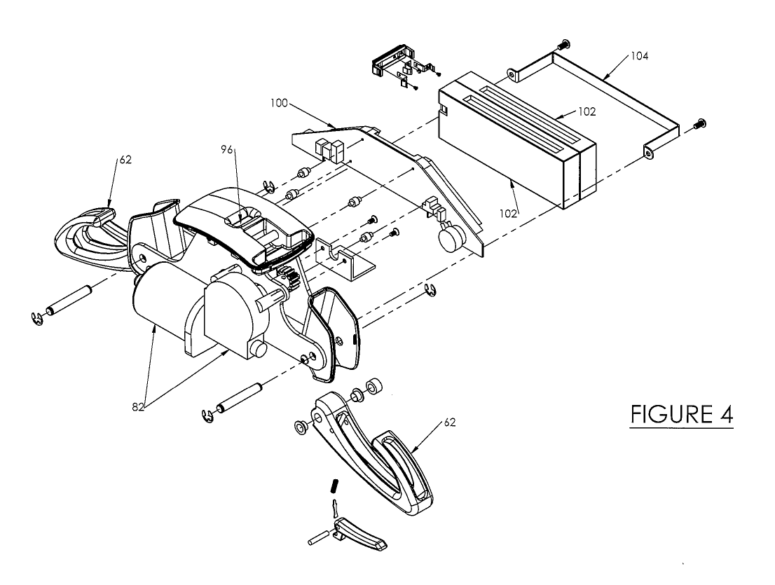

Referring now to FIGS. 2, 3, and 4, the internal components of lift 50 include a preferred component frame assembly comprising first frame plate 74 and second frame plate 76. Plates 74, 76 are preferably positioned so as to be opposed to one another. They preferably, though not necessarily, are positioned so as to define two substantially parallel planes. In this specification, the side of each plate that faces the opposite plate, or the space between the plates, will be called the “inner” side. The opposite side of each plate will be called the outer side. Plates 74, 76 are fixed to one another by at least one plate connector, preferably comprising one or more connecting bars 78. Most preferably, there are five bars 78. Bars 78 and plates 74, 76 together function as a framework for the motor, gear and other components.

One end of each bar 78 is affixed to first frame plate 74, with the other end being affixed to frame plate 76 to hold the first and second frame plates in an opposed position relative to one another. The space between the frame plates comprises an interior component space 80. As can be best seen in FIG. 2, access to interior component space 80 and to each gear component as described below, is available between frame plates, advantageously allowing the interior component space and gear components to be accessed for maintenance, or for some other reason, without plates 74, 76 being detached or disconnected. Both gears 88, 90 are positioned so as to be accessible via at least one opening between the frame plates, without the requirement to disassemble or disconnect either gear.

It will be appreciated by those skilled in the art that, while gear failures are relatively uncommon, the gears need to be greased regularly. This is usually done by brushing grease onto the gears with a small brush. Because the gears are accessible through the opening 110 between plates 74, 76, a worker can reach between plates 74, 76 to brush grease onto the gears. By contrast, with the prior art component box, the gears would need to be removed to be greased.

The lift 50 preferably further includes an electric motor 82 which drives a shaft 84. The shaft 84 preferably extends through opening 86 in plate 74 and is operatively connected to drive gear 88. Opening 86 functions as a gear coupling opening in plate 74, allowing gear 88 to be operatively coupled to motor 82 via shaft 84.

Drive gear 88 is operatively engaged with driven gear 90. As will be appreciated by those skilled in the art, the radius of drive gear 88 and the radius of driven gear 90 are mutually sized to provide substantial mechanical advantage so as to facilitate the motor 82 lifting and lowering a patient.

Driven gear 90 is operatively connected to a patient connector retraction and extension device, preferably in the form of spool 92. Spool 92 has strap 64 attached to it. As shaft 84 turns, thus turning drive gear 88, driven gear 90 is rotated, thus turning spool 92. When components 84, 88, 90 and 92 are being turned in a patient-lowering direction, strap 64 is unwound and extended from spool 92. When the patient is being lifted, strap 64 is wound and retracted onto spool 92. Roller 94, positioned above spool 92, functions to retain strap 64 in a generally vertical orientation. The rollers 94 are rotatably fixed to the plates 74, 76, and rotate as the strap 64 moves through rollers 94 as it is wound or unwound. Strap 64 extends through opening 96 in housing 52 at the top of the lift 50.

In the preferred embodiment gears 88, 90, and spool 92 comprise a gear assembly for operating with motor 82 to lift and lower the patient. It will be appreciated, however, that different forms of gear assembly are comprehended by the invention.

The lift 50 further includes limit switches 98 operatively connected to motor 82 and control circuit board 100. The limit switches 98, by delivering the relevant signal to control circuit board 100, cause motor 82 to shut off when lift 50 reaches its maximum height or minimum height.

Board 100 is operatively connected to motor 82, control panel 54, and plug 60. Thus, control signals received from control panel 54, or a remote control connected to plug 60, are routed to board 100, which preferably acts as a controller with control circuitry to send signals to motor 82 to lift or lower the patient. Board 100 is preferably mounted to the outer side of plate 76.

Preferably, the lift 50 is powered by a power source, most preferably in the form of rechargeable batteries 102, held in place by battery holder 104. The batteries 102 are preferably mounted on the outside of plate 76, immediately below board 100. Batteries 102 are preferably operatively connected to board 100, motor 82, control panel 54 and plug 60 to facilitate operation of lift 50.

It will be appreciated that the invention comprehends other means of powering lift 50. For example, though much less preferred, a lift might be powered by a cable connected to a wall outlet, or by some other power source.

In the preferred embodiment, motor 82 is mounted to the outer side of plate 74 (i.e. the side facing away from space 80), while board 100 is mounted to the outer side of plate 76. Drive gear 88 is coupled to motor 82, and positioned within gear component space 80. Driven gear 90 and spool 92 are also preferably positioned in the gear component space 80.

It will be appreciated that the component frame assembly of the present invention is configured to provide generous access to all of the components that may require maintenance. As can be seen in FIGS. 2-4, once housing 52 is opened, there is immediate, simple, easy access to motor 82. The reason is that motor 82 is positioned on the outer side of plate 74. Thus, there are no gear or other components, and no frame plates, that interfere with access to motor 82 for maintenance or any other reason. Furthermore, access to motor 82 does not require the framework, consisting of plates 74 and 76 and bars 78, to be disassembled or otherwise taken apart.

The preferred component frame assembly of the present invention is also configured to provide generous access to drive gear 88, driven gear 90, and spool 92. These components are located in interior component space 80. Drive gear 88 is positioned so as to be accessible through the space between plates 74 and 76 adjacent to drive gear 80. This drive gear access path is indicated by reference numeral 105. The drive gear access path is unobstructed by any frame plate, and is also unobstructed by gear 90, spool 92 and motor 82. Thus, access to gear 88 does not require disconnection or displacement of components 88, 90, 92 and 82, and requires neither partial nor complete disassembly of the framework.

This is to be contrasted with a typical prior art framework, which consists of a component box in the form of a cube or rectangular parallelopiped. In this prior art configuration, it is typical for the motor to be at the bottom of the box with the drive gear. The driven gear and spool are usually above the motor in the box, with rollers positioned in the top opening of the box. As a result, the gears, roller and spool need to be removed to access the motor. The spool and rollers need to be removed to access the gear. By contrast, in the preferred embodiment of the present invention, the motor 82 is accessible without needing to get past or move gear components 88, 90. The gears 88, 90 are both accessible through the opening 110 between the plates 74, 76 without moving or disconnecting motor 82 or rollers 94. Similarly, board 100 is accessible on the outer side of plate 76, as are batteries 102.

It will further be appreciated that the preferred configuration typically produces a component frame assembly that weighs substantially less than the prior art configuration. The prior art gear box typically comprises five metal walls, and is thus quite heavy. By contrast, the preferred component frame assembly framework comprises two plates and connecting bars, typically a lighter framework.

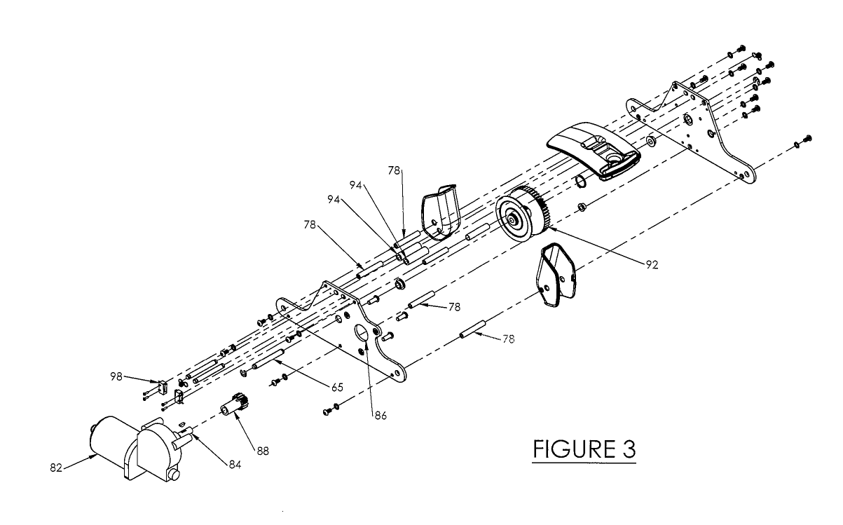

It will be appreciated by those skilled in the art that there are certain components of the lift 50 that will require maintenance or replacement particularly often. One such component is circuit board 100. One of the most common types of malfunction in lift 50 is a malfunction in the electronics on board 100. Typically, for cost reasons, such a malfunction is remedied by replacing the entire board 100. As can be seen in FIGS. 2 and 3, the board 100 is mounted to the outer side of plate 76. It will be appreciated that the invention comprehends mounting the board 100 elsewhere, but it is preferred to mount it to the outer side of one of plates 74, 76.

In the preferred embodiment, board 100 is mounted to plate 76 by screw connectors 106. Thus, to disengage board 100 from plate 76, housing 52 is opened screw connectors 106 are disengaged, and board 100 is removed. New board 100 is then attached to plate 76 by screw connectors 106.

Another component that requires relatively frequent replacement is batteries 102. Specifically, it is typical for batteries 102 to stop being able to hold and/or deliver power long before end of the life of the lift 50. It is thus common for multiple battery replacements to occur during the life of lift 50. In the preferred embodiment, batteries 102 are mounted on the outer side of plate. Holder 104 is connected by screws (not shown) to plate 76, and secures batteries 102 by holding them against plate 76. It will be appreciated that the batteries 102 could be positioned in a different location and still be comprehended by the invention, but that it is desirable for the batteries 102 to be positioned to an outer side of plate 74 or plate 76, for ease of access.

To remove batteries 102, holder 104 is unscrewed from plate 76, and batteries 102 are removed. To insert new batteries 102, they are placed against plate 76, and holder 104 is attached to plate 76 to hold new batteries 102 in place.

Another component that often requires replacement is the fuses, which regulate current flow on the board 100, and possibly to other components as well. The fuses sometimes blow as a result of too much current, and need to be replaced. Preferably, the fuses are positioned on board 100. To replace the fuses, the old ones are detached from board 100 and new ones attached.

Another component that often requires replacement is the limit switches 98. Because these switches are actuated frequently, and for various other reasons, the limit switches often require replacement. In the preferred embodiment, the limit switches 98 are positioned on the outer side of plate 74, above motor 82. However, it will be appreciated that the limit switches can be positioned elsewhere and still be comprehended by the invention. To replace the limit switches 98, they are detached from plate 74, and new ones attached.

Another component that is replaced fairly frequently is strap 64. As the number of uses of lift 50 increases, strap 64 can become frayed or worn out, and require replacement, long before the end of the life of lift 50. In the preferred embodiment, spool 92 is positioned in the interior component space 80, just below rollers 94 and adjacent opening 110. Strap 64 is wound on spool 92. To replace strap 64, strap pin 65 is removed, old strap 64 is removed from spool 92, new strap 64 is attached, and pin 65 is reattached.

It will be appreciated that the ability to, in the preferred embodiment, replace the limit switches, strap, batteries, circuit board and fuses, as well as to grease the gears, all without dismantling the frame, stems from the fact that the preferred framework comprises two opposed plates, with an interior component space between them, and with the plates being fixed together by bars 78. The limit switches, batteries, circuit board and fuses are all, preferably, positioned on the outer side of one of the plates 74, 76.

Meanwhile, the opening 110 between the plates preferably extends over substantially the whole of the perimeter of the plates. The word “perimeter” is being used to denote the length of the edge 114 of a plate. However, it will be appreciated that the preferred embodiment of the invention comprehends that the opening will extend over at least fifty percent of the perimeter of the plates. Also, the opening referred to herein need not be contiguous to be comprehended by the invention.

This can be contrasted with the prior art, in which the lift components were positioned inside a component box, typically with no components on the outside of the box, and only a small opening leading to the space inside the box. The result of the prior art configuration was that components were difficult to reach, and most or all of the lift components needed to be dismantled and, even for simple maintenance like replacing batteries or a circuit board. In the present invention, more components are positioned on the outer portion of the framework, and even those positioned between the plates are accessible through opening 110.

Hooks 62 are preferably mounted between plates 74, 76 by means of pins 112. Pins 112 are preferably positioned adjacent the edges of plate 74 and plate 76, and are attached to both plates. To remove the hooks 62 (say, for replacement purposes), pins 112 are removed, new hooks put in place, and pins 112 reinserted and fastened to plates 74, 76.

It will be appreciated that this invention is also applicable to other types of lifts not previously discussed herein, such as, for example, manual lifts i.e. lifts where the force for lifting and lowering the patient is applied manually, not by a motor attached to the lift. In motorized lift, it is the motor that acts as a force applicator (i.e. that element or combination of elements that applies force to lift and/or lower the patient. However, in a manual lift, other force applicators are possible, such as, for example, a crank or lever. In such an alternative configuration, the force applicator may be attached to the framework at any location where the motor is attached, or any other location that permits the application of lifting and lowering force. It will be appreciated that, in most manual lifts, there would be no controller, since there would be no motor that would need to be controlled.

It will further be appreciated that the gear assembly of the present invention is one example of a force transmitter, (i.e. an element or combination of elements that transmits force from the force applicator to the strap). Other configurations of force transmitters are also comprehended by the invention (e.g. pulleys, a shaft). What is required is that force be transmitted so as to cause the patient to be lifted or lowered.

Various modifications and alterations are possible to the form of the invention without departing from the scope of the broad claims as attached hereto. For example, the specific positions of the limit switches, circuit board, batteries fuses, hooks, strap and gears may differ from the preferred embodiment while still being comprehended by the invention. What is important is that the component frame assembly for the lift device be configured to be easier to maintain than certain prior art configurations.

The invention claimed is:

1. A component frame assembly for a patient lift device, the component frame assembly comprising:
first and second opposed frame plates, and at least one plate connector connecting the plates, the plates and plate connector being sized, shaped and positioned such that the plates are separated by an interior component space and so as to define an opening to the interior component space between an edge of the first plate and an edge of the second plate, each plate having an inner side facing the interior component space and an opposite outer side;
a force transmitter coupled to the plates and positioned in the interior component space;
a force applicator mounted to the outer side of one of the first and second frame plates.

2. A component frame assembly as claimed in claimed 1, wherein the force transmitter comprises a gear assembly.

3. A component frame assembly as claimed in claim 1, where the force applicator comprises a motor.

4. A component fame assembly as claimed in claim 3, the assembly further comprising a controller mounted to the outer side of one of the first and second frame plates.

5. A component frame assembly as claimed in claim 4, the assembly further comprising a power source, the power source being coupled to the plates and positioned on an outer side of one of the plates.

6. A component frame assembly as claimed in claim 1, wherein the opening extends over at least fifty percent of the perimeter of the plates.

7. A component frame assembly as claimed in claim 1, wherein the assembly includes a patient connector retraction and extension device positioned in the interior component space adjacent said opening.

8. A component frame assembly as claimed in claim 7, wherein the patient connector retraction and extension device comprises a spool for retracting and extending a patient connector.

9. A component frame assembly as claimed in claim 4, wherein the assembly further comprises at least one limit switch to limit operation of the motor, the limit switch being positioned on an outer side of one of the plates.

10. A component frame assembly as claimed in claim 4, wherein the assembly further comprises at least one current-controlling fuse, the fuse being positioned on an outer side of one of the plates.

11. A component frame assembly as claimed in claim 5, wherein the power source comprises a pair of batteries.

12. A component frame assembly as claimed in claim 4, wherein the controller comprises a circuit board that includes control circuitry.

13. A component frame assembly as claimed in claim 12, wherein the assembly further comprises a power source coupled to the plates and positioned on an outer side of one of the plates, and wherein the circuit board is positioned between one of the plates and the power source.

14. A component frame assembly as claimed in claim 4, wherein the motor is positioned on an outer side of the first plate.

15. A component frame assembly as claimed in claim 14, wherein the assembly further comprises at least one limit switch to limit operation of the motor, the limit switch being positioned on the outer side of the first plate.

16. A component frame assembly as claimed in claim 15, wherein the controller is positioned on an outer side of the second plate.

17. A component frame assembly as claimed in claim 16, wherein the assembly further comprises a power source, the power source being coupled to the plates and positioned toward an outer side of the second plate.
